(19) United States
(12) Patent Application Publication
(10) Pub. No.: US 2006/0245364 A1
(43) Pub. Date: Nov. 2, 2006

(54) Bi-directional continuous voice and video quality testing system with TTMF tones

(76) Inventors: Xing Zhu, Singapore (SG); David Kam Wing Lau, Singapore (SG); Dennis Seow Hee Goh, Singapore (SG)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/093,842

(22) Filed: Mar. 29, 2005

(51) Int. Cl. H04J 1/16

(52) U.S. Cl. 370/241

(57) ABSTRACT

A continuous bi-directional file-play-record voice and video quality tester system (“CFPR-VVQT”) for measuring the quality of voice or video communication links from a customer premises equipment (“CPE”) through a Network under Test to a voice and video quality tester (“VVQT”). The start and end of a set of quality testing sample signals are determined by a start flag signal and an end flag signal, respectively, generated by the CFPR-VVQT. The flag signals may be triple tone modulation frequency (“TTMF”) tones. The CFPR-VVQT will measure the quality testing sample signals, determine a signal quality test result, and then transmit the test results back through Network under Test to the originating VVQT.

### BACKGROUND OF THE INVENTION

1. Field of Invention

The invention relates to telecommunication systems, and in particular, to telecommunication systems utilizing voice and video quality testing.

2. Related Art

The worldwide utilization of telecommunication systems is growing and adapting at a rapid pace and telephone and other service providers are continuously attempting to improve the quality of the voice and video communications that are carried on their telecommunication networks. In general, telephone service providers provide voice communications, while other service providers provide video communications, e.g., cable broadband companies.

With respect to telephone service providers, these telecommunication networks are typically known as public switched telephone networks (“PSTNs”). With the advent of modem digital communication systems, many of these telephone service providers are utilizing digital communication techniques to communicate both voice and data signals across their PSTNs rather than transmitting analog voice signals generated from the speech of the user of a telephone at a customer premises (such as the user's home or office). The PSTN may convert an analog voice signal to a digital data signal that is transmitted through the numerous components of the PSTN before being converted back into a second analog voice signal that is transmitted to a second telephone at another customer premises.

Generally known as Voice over Network (“VoN”), or Voice over Packet (“VoP”), this new telephone technology relies on packet-oriented digital networks delivering voice communication services as a digital stream. By sampling speech and recording it in digital form, encoding the digitized speech into packets, and transmitting the packets across different computer networks, VoN systems offer a lower cost alternative to the original PSTNs due to their inherent efficiencies and lower bandwidth requirements.

At present, the most popular example of VoP is the Voice over Internet Protocol (“VoIP” or “Voice over IP”) services that utilize the Internet Protocol (“IP”). Additional examples include voice over frame relay (“VoFR”), voice over asynchronous transfer mode (“VoATM”), voice over digital subscriber line (“VoDSL”), and voice over cable (“VoCable”).

These packet-oriented digital networks, such as such as the Internet, Ethernets and wireless networks, may also support other forms of media. As a result, digital video systems are replacing existing analog video systems and making possible many new telecommunication services (e.g., direct broadcast satellite, digital television, high definition television, video teleconferencing, telemedicine, e-commerce and Internet video) that are becoming an essential part of the U.S. and the world economy. Thus in addition to bursty non-real-time applications such as e-mail and file data transfers through numerous types of protocols including the file transfer protocol (“ftp”), this new digital technology now also supports real-time applications such as digital television, video teleconferencing and Internet video.

Unfortunately, these digital techniques have made maintaining high levels of voice and video quality more complex because of the following factors. Because of the required higher bandwidth, these systems use voice and data compression and decompression algorithms when transmitting signals. Also, there are the problems inherent in any network, such as packet loss, noise, signal attenuation, and echo.

Three important parameters of voice quality are (1) signal clarity; (2) transmission delays; and (3) signal echoes. These parameters are applicable to video quality, which is also is subject to additional visual impairments, such as tiling, error blocks, smearing, blurring, and edge noise. Ideally, there should be a set of performance parameters where each parameter is sensitive to some unique dimension of voice and video quality type or impairment type.

In addition, measuring voice and video quality should be done in-service since taking the telecommunications system out-of-service and injecting known test signals will change the conditions under which the telecommunications system is actually operating. Therefore, because the performance of digital telecommunications systems is variable and dependent upon the dynamic characteristics of both the input media and the digital transmission, performance monitoring must be continuous, non-intrusive, and in-service. Moreover, with respect to wireless networks (e.g., mobile or cell phones), additional problems are created because of poor mobile phone quality, noise, acoustic and landline echo, and other distortions. As a result, transmission conditions that pose little threat to non-real-time data traffic may introduce severe problems to real-time packetized voice and video traffic. These conditions include real-time message delivery, gateway processes, packet loss, packet delay, and the utilization of nonlinear codecs.

While the impact of voice and video quality is subjective in nature, objective measurement tools that effectively and inexpensively measure the voice and video quality over the network under test are required by end-users and service providers. These measurement tools must continuously, reliably and objectively measure the results of transmissions of voice and video over the network under test in both directions. Such results may be used by end-users and service providers, for example, for specification and evaluation of system performance, comparison of competing services, network design, maintenance and troubleshooting, and optimization of limited network resources by determining the exact effects of network configuration and design changes.

The VoN industry has developed a number of test standards for measuring the quality of voice communication across packet-based networks. These test standards include: (a) the International Telecommunication Union (“ITU”) Perceptual Speech Quality Measure (“PSQM”), as described in ITU-T Recommendation P.861, titled “Objective quality measurement of telephone-band (300-3400 Hz) speech codecs;” (b) the Perceptual Evaluation of Speech Quality (“PESQ”), as described in ITU-T Recommendation P.862, titled “Perceptual evaluation of speech quality (“PESQ”): An objective method for end-to-end speech quality assessment of narrow-band telephone networks and speech codecs;” (c) the MOS-LQO described by ITU-T Recommendation P.800.1, titled “Mean Opinion Score (MOS) terminology;” (d) the ITU-T Recommendation P.563, titled “Single ended method for objective speech quality assessment in narrow-band telephony applications;” and (e) the R-Factor described by ITU-T Recommendation G.107, titled “The E-model, a computational model for use in transmission planning,” all of which objectively measure audio quality and are incorporated herein by reference.

With respect to measuring video quality across packet-based networks, the most widely used standard is American National Standards Institute (“ANSI” ) T1.801.03-2003, “American National Standard for Telecommunication—Digital Transport of One-Way Video Signals—Parameters for Objective Performance Assessment.” ANSI T1.801.03-2003 defines an entire framework of objective parameters that can be used to measure the quality of digital video systems. There are also other American National Standards that can be used to gauge the quality of other aspects of digital video systems, e.g., ANSI T1.801.01-1995, ANSI T1.801.02-1996, and ANSI T1.801.04-1997.

Specialized voice test equipment for PSTNs is well known and available from a number of providers. The test equipment ranges from simple hand-held testers for service technicians to sophisticated testers for automated network management. These testers are intended to enable telephone technicians to verify the proper operation and quality of voice communication on the PSTN and to track down faults.

Remote telephone test units, also known as responders, provide added flexibility to the testing of telephone lines and equipment by providing calibrated reference signals and by measuring and detecting received signals. These responders are designed primarily for performing tests over circuit-switched connections.

Video quality measurements have a shorter history than that of voice quality measurements. Generally, subjective testing techniques are more widely used presently. Objective video quality estimation software is available that records and measures video signals in accordance with ANSI T1.801.03-2003. Video processing, however, is more cumbersome because it entails use of recording and playback devices that may include digital video tape recorders, digital audio tape machines, CD players, and analog audio cassette machines.

A Voice/Video Quality Tester (“VVQT”) is any device that measures various parameters of a voice or video signal to quantify the impairments created by transmission of that signal over a telecommunication network. The measurement set of the VVQT is specifically selected to analyze the type of signal being transmitted over either a circuit-switched or packet-switched telecommunication network and the relevant measurements may include clarity, echo, packet loss, network signal loss, network delay, distortion, blurring, tiling, etc., depending on the media being tested.

As an example, FIG. 1 shows an existing voice/video quality measurement system 100 utilized to continuously test the connection between two devices (referred to as customer premise equipment [“CPE”]) located at two separate locations 102, 112. A Network under Test 110 is tested using VVQT₂ and VVQT₂ 114. For example, CPE₁ and CPE₂ may be video cameras used for remote video teleconferencing and VVQT₁ 102 and VVQT₂ may be testing devices that include audio/video recording and playback devices and the appropriate testing software.

The measurement process begins by establishing a network connection between location 102 and location 112. The connection may be over the Internet and VVQT₁ 102 may, in the case of a voice system, be transmitting a VoIP packet or, in the case of a video system, a video packet for video teleconferencing, to VVQT₂ 104. The network connection established in the direction of CPE₂ 116 and VVQT₂ 114 is referred to as the uplink 120 and the network connection established in the direction of CPE₁ 106 and VVQT₁ is referred to as the downlink 124. Once the network connections are established and the media path is active, a measurement set may be selected and configured to analyze the data path through the Network under Test 110. For example, a voice or video packet is transmitted to the Network under Test 110 by VVQT₁ 104. The degraded voice or video packet is received and recorded by VVQT₂ 114 and the uplink 120 voice/video quality score is then determined using the appropriate standard to compare the degraded voice or video packet with the original or a reference packet.

The process is repeated in the direction of VVQT₁ by VVQT₂ 114 transmitting a voice or data packet to VVQT₁ by way of the downlink 124. The degraded voice or data packet is received and recorded by VVQT₁ 102 and the voice/video quality score for the downlink 124 is then determined using the same standard utilized to measure the uplink 120 voice/video quality score. The results are transmitted over the Network under Test 110, and then received and processed by the VVQT₂ 114, with the results subsequently displayed at either VVQT₂ 114, VVQT₁ 104, or both.

A Testing Circle may be defined as a single testing cycle consisting of a test of one uplink 120 transmission and one downlink 124 transmission. To continuously test the Network under Test 110, the Testing Circles are continuously repeated. FIG. 2 is a signal flow diagram (which may also be referred to as a “sequence diagram”) of an example conventional process for synchronizing bi-directional continuous file transfer testing data exchange between two VVQTs.

In FIG. 2, the process starts in step 206, where synchronization begins between VVQT₁ 202 and VVQT₂ 204. Essentially, this comprises of establishing a network connection between and VVQT₁ 202 and VVQT₂ 204 and determining which of the two VVQT's will initiate a Test Circle.

In step 208, VVQT₁ 202 initiates the Test Circle by playing a file, e.g., transmitting a voice or video packet, and VVQT₂ 204 is placed in record mode to receive the packet sample and record it for testing purposes in step 210. For the play-record operation in the opposite or downlink direction, the steps 212, 214, and 216 are repeated. This completes one Test Circle. This may be followed by a second Test Circle, comprising steps 218, 220, 222, 224, 226, and 228, which are identical to the corresponding steps in the prior Test Circle.

The process in FIG. 2 shows that synchronization between VVQT₁ 202 and VVQT₂ 204 is required each time either of these two VVQT's transmits and receives packet samples for testing. That is, synchronization requires that when one VVQT transmits a sample packet for testing, the receiving VVQT must be configured to accept the sample packet and then record and test the sample packet. If continuous, bidirectional testing is desired, synchronization is required for each uplink or downlink.

Such synchronization entails overhead in that synchronization requires time, sometimes an additional 20 seconds, whereas the actual voice/video testing sample itself may be approximately 8.0 seconds in length. This may significantly reduce the efficiency of a voice and video quality testing system, particularly one that is operating continuously and is testing in-service a mobile phone system that is in motion, e.g., in an automobile.

The second problem is that the synchronization may not be very reliable because of the inherent problems in the network under test, e.g., packet loss, packet delay jitter, signal attenuation, and noise. This problem may be exacerbated when testing mobile phone systems where one or both of the VVQT's used for testing may be mobile, e.g., in a moving vehicle such as a van. Moreover, in the future, VVQT's may be embedded in a mobile telephone. In this case, the network under test is not a fixed line telecommunications system but one with mobile communication links in which the exchange of voice/video quality test results are not as easily done.

Unfortunately, existing VVQT systems do not provide solutions for these problems. Existing VVQT devices that support continuous and bi-directional voice and video quality testing require synchronization between the record and play processes that is time-consuming and potentially unreliable. Moreover, additional problems exist in voice and video testing systems when testing mobile communication links because existing testing systems do not readily support the exchange of test results between devices utilizing such links. Therefore, a need exists for a voice and video quality testing system that allows bidirectional, real time, and in-service objective testing of the quality of the communication link being used, efficiently, inexpensively, conveniently and quickly at any time.

### SUMMARY

A continuous bi-directional file-play-record voice and video quality tester (“CFPR-VVQT”) system and method are described for measuring the quality of a voice or video communication link from one customer device through a Network under Test to at least one other remote customer device. The CFPR-VVQT is capable of establishing communication links between itself and the CPEs, receiving quality testing sample signals from each of the CPEs, and transmitting these sample signals through the Network under Test to a voice and video quality tester (“VVQT”). A VVQT receiving quality testing sample signals will record the signals in memory, measure the recorded quality testing sample signals, determine a signal quality test result, and then transmit the test results back through Network under Test to a second VVQT. Quality testing sample signals are sent from one VVQT to another VVQT with a start flag signal and an end flag signal at the start and the end, respectively, of the quality testing sample signal. Decoding these flag signals allows a VVQT to match its recording and testing of quality testing sample signals with their transmission by the other VVQT. The flag signal may also be used to transmit test results from one VVQT to another. Flag signals may be triple tone modulation frequency (“TTMF”) tones.

As an example of implementation of a VVQT in a CFPR-VVQT, the VVQT may include an Encode/Play Module in signal communication with at least one CPE and the Network under Test, a Decode/Record Module in signal communication with the Encode/Play Module and the Network under Test, a Testing Module in signal communication with the Encode/Play Module and the Decode/Record Module, and a Storage Module in signal communication with the Encode/Play Module and the Decode/Record Module. The Encode/Play Module is capable of generating the flag signals and transmitting quality testing sample signals to another VVQT, where a Decode/Record Module is capable of decoding the flag signals, recording the quality testing sample signals, and transmitting the quality testing sample signals to the Testing Module. The Testing Module measures the quality of the received quality testing sample signals, using an appropriate measurement set dependent on the media, i.e., voice or video. Test Results may be stored in the Storage Module and may also be embedded in flags signal and subsequently transmitted to the sending VVQT.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a block diagram of an existing voice/video quality measurement system utilized to continuously test the connection between two locations with voice or video devices through a Network under Test.

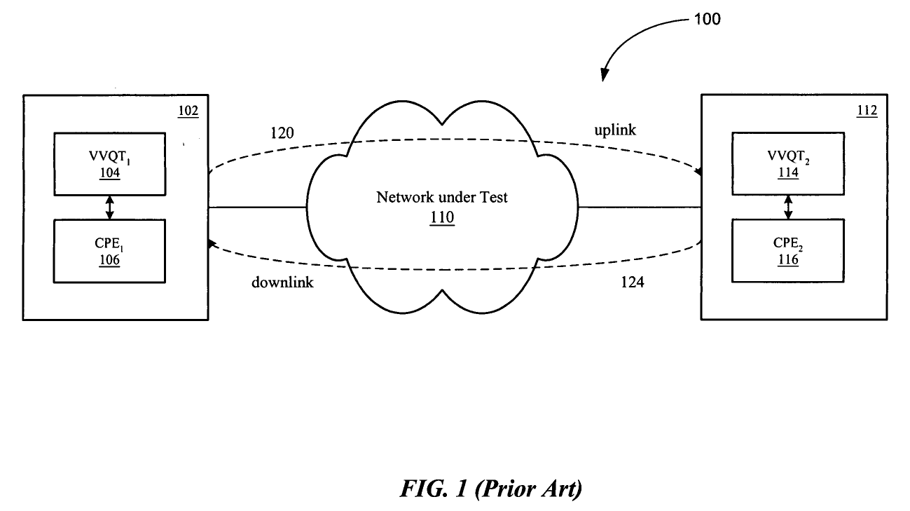

FIG. 2 is a signal flow diagram of an example conventional process for synchronizing bi-directional continuous file transfer testing data exchange between two VVQTs.

FIG. 3 is a signal flow diagram of an example implementation of the synchronization process in a Continuous File-Play-Record (“CFPR”)-VVQT system.

FIG. 4 is a time sequence diagram of Flag Signals and a sample testing signal generated by the File Play Process of a CFPR-VVQT system.

FIG. 5 is another time sequence diagram of Flag Signals and a sample testing signal generated by the File Play Process of a CFPR-VVQT.

FIG. 6 is a block diagram of an example CFPR-VVQT system with TTMF.

FIG. 7 is a flow chart for a TTMF generator of an example CFPR-VVQT system.

FIG. 8 is a flow chart for a TTMF detector of an example CFPR-VVQT system.

### DETAILED DESCRIPTION

In the following description of the preferred embodiment, reference is made to the accompanying drawings that form a part hereof, and which show, by way of illustration, a specific embodiment in which the invention may be practiced. Other embodiments may be utilized and structural changes may be made without departing from the scope of the present invention.

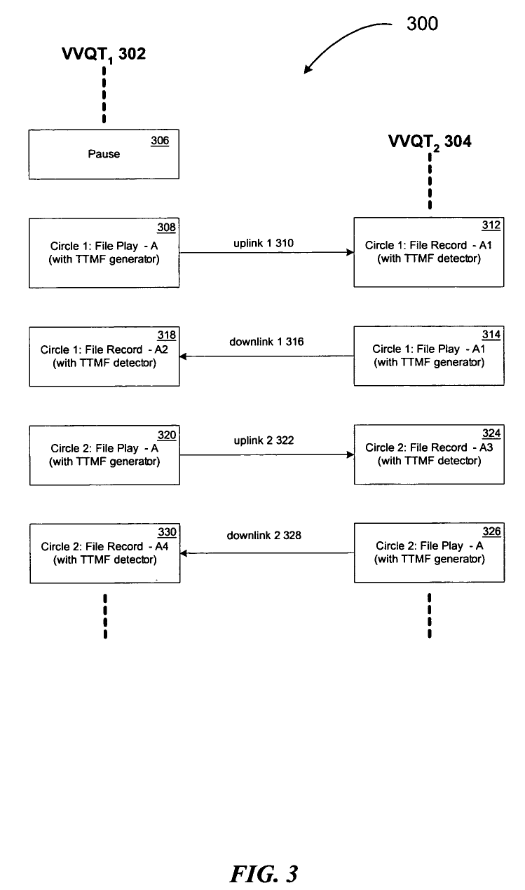

FIG. 3 is a signal flow diagram of an example implementation of the synchronization process in a CFPR-VVQT system. This synchronization process may utilize a Triple Tone Modulation Frequency (“TTMF”) tone to generate start and end flag signals (known as S-TTMF and E-TTMF signals, respectively) to signal the start and the end, respectively, of the playing and recording of a test sample. Dual Tone Modulation (or Multiple) Frequency (“DTMF”) tones or signals are well known in telecommunications. The signal generated by a DTMF encoder is a direct algebraic summation, in real time, of the amplitudes of two sine (cosine) waves of different frequencies. The touch tone telephone system uses pairs of tones to represent the various keys. To improve the efficiency of the CFPR-VVQT system, a TTMF tone may be used. Moreover, by embedding test results in the start and end flag signals, the CFPR-VVQT system is able to exchange test results regardless of the type of Network under Test,

The TTMF tone consists of three sinusoids with three different frequencies. The different frequencies may be chosen differently for different applications or testing. For the example implementation of the synchronization process described below, eleven frequencies are used, as show in Table 1.

TABLE 1
Frequency Bank Used for TTMF.

| | Name | | | | |
|---|---|---|---|---|---|
| | f1 | f2 | f3 | f4 | f5 |
| Frequency | 650 Hz | 750 Hz | 850 Hz | 950 Hz | 1050 Hz |

Name

| | f6 | f7 | f8 | f9 | f10 | f11 |
|---|---|---|---|---|---|---|
| Frequency | 1150 | 1250 | 1350 | 1450 | 1550 | 1650 |
| | Hz | Hz | Hz | Hz | Hz | Hz |

In order to avoid harmonics, the three frequencies comprising a TTMF tone may be chosen according to the following rules:
(a) no frequency is a multiplier of another frequency;
(b) the difference between any two frequencies is not equal to any of the frequencies; and
(c) the sum of any three frequencies is not equal to any of the frequencies.
   Thus a permitted TTMF tone is a tone signal comprising, e.g., three frequencies such as ƒ1, ƒ6, and ƒ7 (as shown in the second column of Table 1).

The CFPR-VVQT system uses TTMF Flag Signals to implement the synchronization process and to exchange voice and video quality test results. As an example, the CFPR-VVQT system may use a File Start TTMF (“S-TTMF”) Flag Signal and a File End TTMF (“E-TTMF”) Flag Signal. The S-TTMF has two functions: (a) indicating the start of the played voice/video sample testing file; and (b) representing the integer part of a voice/video quality measurement result. For example, for a voice/video quality measurement using the PESQ Standard, a PESQ score of 4.23 would result in the integer portion of the test score, 4, being encoded into and sent out with the S-TTMF. In order to implement these two functions, the S-TTMF may be implemented as shown in Table 2.

TABLE 2
TTMF Frequency Combinations for the S-TTMF Flag Signal.

| | Digit | | | | |
|---|---|---|---|---|---|
| | 0 | 1 | 2 | 3 | 4 |
| TTMF | (f1, f6, f7) | (f2, f6, f8) | (f3, f6, f9) | (f4, f6, f10) | (f4, f6, f11) |
| Fre- | | | | | |
| quency | | | | | |
| Combi- | | | | | |
| nation | | | | | |
| | Digit | | | | |
| | 5 | 6 | 7 | 8 | 9 |
| TTMF | (f1, f6, f8) | (f2, f6, f9) | (f3, f6, f9) | (f4, f6, f11) | (f5, f6, f7) |
| Fre- | | | | | |
| quency | | | | | |
| Combi- | | | | | |
| nation | | | | | |

It may be noted that in Table 2, frequency ƒ6 is present in all TTMF combinations shown and thus has been chosen to represent that the playing file is starting. In other words, if the frequency ƒ6=1150 Hz is detected in any TTMF tone, then this TTMF tone is an S-TTMF Flag Signal that may also embody the integer portion of a voice/video quality measurement result.

The second type of Flag Signal, the E-TTMF Flag Signal, also has two functions: (a) indicating the end of the played voice/video sample testing file; and (b) representing the two digit decimal portion of the voice/video quality measurement result. For example, with reference to the same PESQ score of 4.23, the two digit decimal portion of the score, 23, would be encoded into and sent out with the E-TTMF. The first function may be easily implemented by not using the special frequency f6 in any E-TTMF Flag Signal because this special frequency is used only by the S-TTMF Flag Signal. Thus the E-TTMF Flag Signals may be implemented as shown in Table 3.

TABLE 3
TTMF Frequency Combinations for the E-TTMF Flag Signal.

| | | | | | | | | | | |
|---|---|---|---|---|---|---|---|---|---|---|
| Two Decimal | 00 | 01 | 02 | 03 | 04 | 05 | 06 | 07 | 08 | 09 |
| Digits | | | | | | | | | | |
| TTMF Frequency | 1, 2, 3 | 1, 2, 4 | 1, 2, 5 | 1, 2, 7 | 1, 2, 8 | 1, 2, 9 | 1, 2, | 1, 2, | 1, 3, 4 | 1, 3, 5 |
| Combination | | | | | | | 10 | 11 | | |
| Two Decimal | 10 | 11 | 12 | 13 | 14 | 15 | 16 | 17 | 18 | 19 |
| Digits | | | | | | | | | | |
| TTMF Frequency | 1, 3, 7 | 1, 3, 8 | 1, 3, 9 | 1, 3, | 1, 3, | 1, 4, 5 | 1, 4, 7 | 1, 4, 8 | 1, 4, 9 | 1, 4 |
| Combination | | | | 10 | 11 | | | | | 10 |
| Two Decimal | 20 | 21 | 22 | 23 | 24 | 25 | 26 | 27 | 28 | 29 |
| Digits | | | | | | | | | | |
| TTMF Frequency | 1, 4, | 1, 5, 7 | 1, 5, 8 | 1, 5, 9 | 1, 5, | 1, 5, | 1, 7, 8 | 1, 7, 9 | 1, 7, | 1, 7, |
| Combination | 11 | | | | 10 | 11 | | | 10 | 11 |
| Two Decimal | 30 | 31 | 32 | 33 | 34 | 35 | 36 | 37 | 38 | 39 |
| Digits | | | | | | | | | | |
| TTMF Frequency | 1, 8, 9 | 1, 8, | 1, 8, | 1, 9, | 1, 9, | 1, 10, | 2, 3, 4 | 2, 3, 5 | 2, 3, 7 | 2, 3, 8 |
| Combination | | 10 | 11 | 10 | 11 | 11 | | | | |
| Two Decimal | 40 | 41 | 42 | 43 | 44 | 45 | 46 | 47 | 48 | 49 |
| Digits | | | | | | | | | | |
| TTMF Frequency | 2, 3, 9 | 2, 3, | 2, 3, | 2, 4, 5 | 2, 4, 7 | 2, 4, 8 | 2, 4, 9 | 2, 4, | 2, 4, | 2, 5, 7 |
| Combination | | 10 | 11 | | | | | 10 | 11 | |
| Two Decimal | 50 | 51 | 52 | 53 | 54 | 55 | 56 | 57 | 58 | 59 |
| Digits | | | | | | | | | | |
| TTMF Frequency | 2, 5, 8 | 2, 5, 9 | 2, 5, | 2, 5, | 2, 7, 8 | 2, 4, 8 | 2, 4, 9 | 2, 4, | 2, 4, | 2, 5, 7 |
| Combination | | | 10 | 11 | | | | 10 | 11 | |
| Two Decimal | 60 | 61 | 62 | 63 | 64 | 65 | 66 | 67 | 68 | 69 |
| Digits | | | | | | | | | | |
| TTMF Frequency | 2, 8, | 2, 9, | 2, 9, | 3, 4, 5 | 3, 4, 7 | 3, 4, 8 | 3, 4, 9 | 3, 4, | 3, 4, | 3, 5, 7 |
| Combination | 11 | 10 | 11 | | | | | 10 | 11 | |
| Two Decimal | 70 | 71 | 72 | 73 | 74 | 75 | 76 | 77 | 78 | 79 |
| Digits | | | | | | | | | | |
| TTMF Frequency | 3, 5, 8 | 3, 5, 9 | 3, 5, | 3, 5, | 3, 7, 8 | 3, 7, 9 | 3, 7, | 3, 7, | 3, 8, 9 | 3, 8, |
| Combination | | | 10 | 11 | | | 10 | 11 | | 10 |
| Two Decimal | 80 | 81 | 82 | 83 | 84 | 85 | 86 | 87 | 88 | 89 |
| Digits | | | | | | | | | | |
| TTMF Frequency | 3, 8, | 3, 9, | 3, 9, | 4, 5, 7 | 4, 5, 8 | 4, 5, 9 | 4, 5, | 4, 5, | 4, 7, 8 | 4, 7, 9 |
| Combination | 11 | 10 | 11 | | | | 10 | 11 | | |
| Two Decimal | 90 | 91 | 92 | 93 | 94 | 95 | 96 | 97 | 98 | 99 |
| Digits | | | | | | | | | | |
| TTMF Frequency | 4, 7, | 4, 7, | 4, 8, 9 | 4, 8, | 4, 8, | 4, 9, | 4, 9 | 5, 7, 8 | 5, 7, 9 | 5, 7, |
| Combination | 10 | 11 | | 10 | 11 | 10 | 11 | | | 10 |

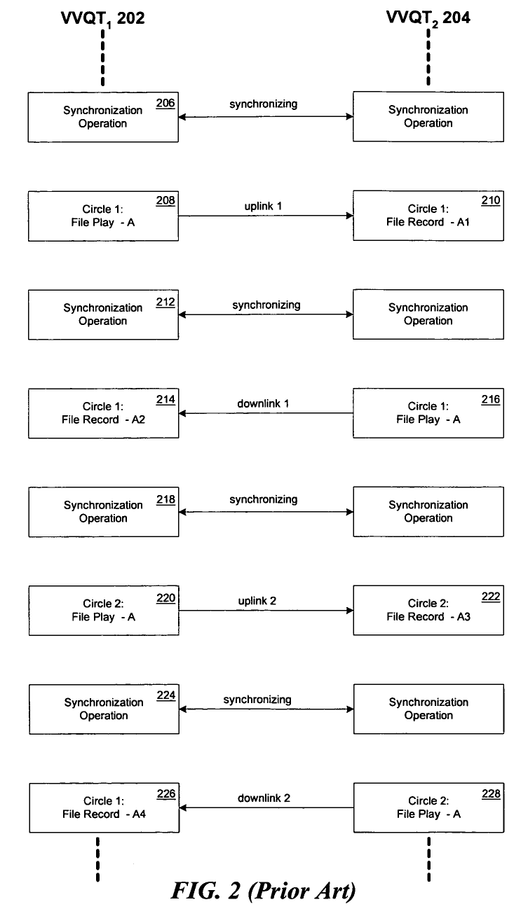

FIG. 3 is a signal flow diagram 300 of an example implementation of the file-play-record process in a CFPR-VVQT system that utilizes the TTMF Start and End Flag Signals shown in Tables 2 and 3 to implement continuous bi-directional voice and video quality testing without the synchronizing shown in FIG. 2. The left column represents those processes taking place in VVQT₁ 302 on the downlink side of a CFPR-VVQT system, the right column those taking place in VVQT₂ 304 on the uplink side of a CFPR-VVQT system. There may be additional VVQT's connected to a single CFPR-VVQT system and each VVQT may be located anywhere in the world including the central office of a PSTN telephone service provider or the different offices of a company utilizing the Internet for VoIP. By the same token, two or more VVQT's may be located at a single site that may be remote from the location of the CPEs that provide the voice/video signals to be tested. Moreover, there may be multiple CPEs on either side of an uplink or downlink comprising a Test Circle.

The process starts in step 306, which is a pause undertaken by VVQT₁ 302 in order to allow VVQT₂ 304 to start its File Record Process 312 before VVQT 302 starts its File Play Process 308 (as will be further explained below with reference to Test Circle 2). Test Circle 1 consists of a File Play process (uplink 1 310) and a File Record process (downlink 2 316). The File Play process starts in step 308, which comprises VVQT₁ 302 generating start and end flag signals, and transmitting these flag signal and a quality testing sample signal from a first CPE (not shown) in signal communication with VVQT₁ 302.

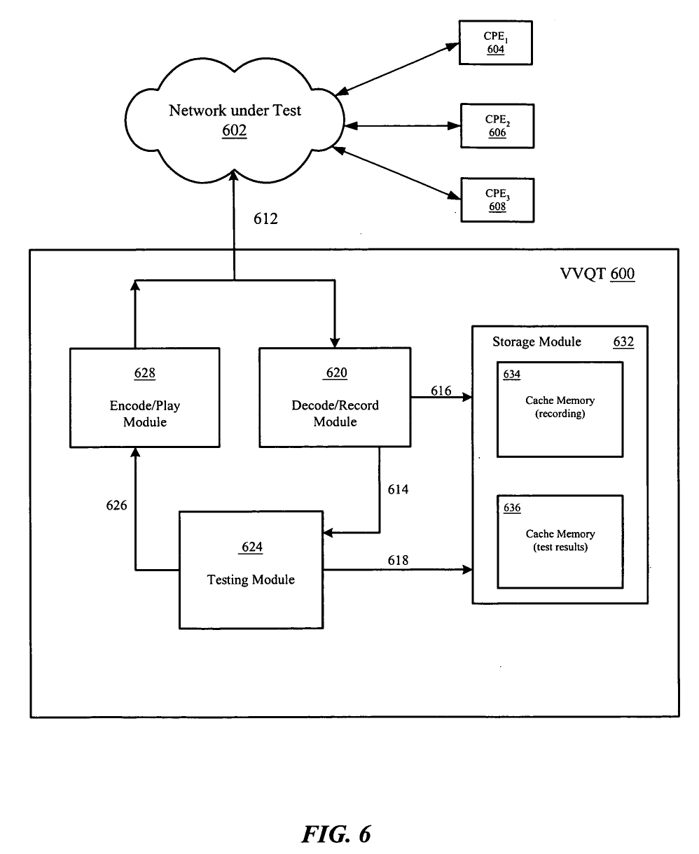

In step 312, VVQT₂ 304 starts a File Record process. This process comprises VVQT₂ 304 receiving the flag signals and the quality testing sample signals, with the start flag and the end flag signals being decoded and used to start and end, respectively, the recording of the quality testing sample signals to memory in VVQT₂ 304. After recording, the quality testing sample signals are transmitted to the Testing Module 624, FIG. 6, where test results are produced using a measurement set appropriate to the type of media being tested.

The downlink 316 portion of Test Circle 1 takes place in steps 314, 316, and 318. These step are the reverse of the uplink 310 portion, with the quality testing sample signals being those received from a second CPE (not shown) in signal communication with VVQT₂ 304. In addition, because VVQT₂ 304 has just obtained test results of the uplink 310 portion, these test results will be embedded in the flag signals generated in step 314, as shown in tables 2 and 3.

Test Circle 1 is followed by Test Circle 2, comprising steps 320, 322, 324, 326, 328, and 330. It should be noted that there is always a pause (such as step 306) before a VVQT begins a File Play process (steps 308, 314, 320, 326) so that the corresponding File Record Process (steps 312, 318, 324, and 330, respectively) has started and is waiting for the opposite VVQT to start its File Play Process. This will ensure that there will be no data lost because quality testing sample signals arrive at a VVQT before it is ready to receive and record them. For example, the File Record Process 324 of VVQT₂ 304 is started and ready to receive quality testing sample signals before the File Play Process 320 of VVQT₁ 302 starts. The pause inserted before File Play Process 320 starts is dependent on the time needed for VVQT₂ 304 to complete its File Play Process 314 and network transmission delay.

FIG. 3 is a signal flow diagram of two Test Circles. These may be followed by other Test Circles, with voice and video quality testing continuing until terminated manually by operator intervention, automatically by lack of quality testing sample signals, or any other method of controlling the operation of the CFPR-VVQT.

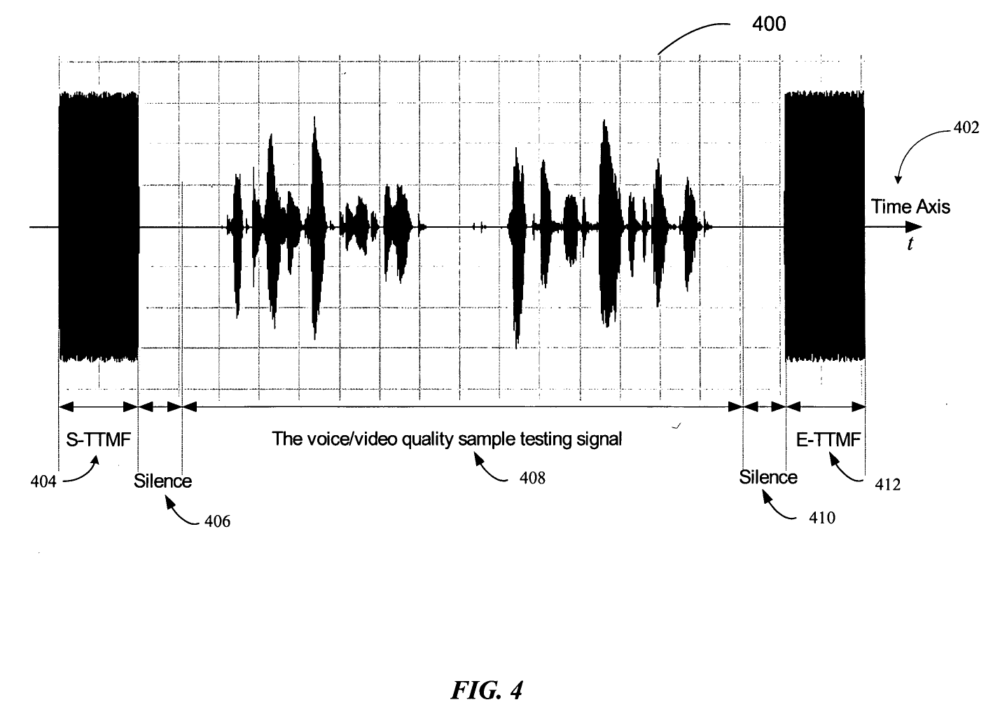

FIG. 4 is a time sequence diagram of Flag Signals and a sample testing signal generated by the File Play Process of a CFPR-VVQT system. Specifically, FIG. 4 is a graphic representation of the uplink 310 task of FIG. 3. FIG. 4 has a horizontal Time Axis t 402, starting at the left of the time sequence diagram. In time sequence 400, a TTMF generator first generates an S-TTMF Flag Signal 404. In order to accommodate different communication systems and adapt to varying testing conditions, the length of the Flag Signals may be manually or automatically adjustable. For a manually adjustable process, the testing operator can initially set the length of the Flag Signal to a standard length, for example, 0.30 second. Then the testing operator observes if the Flag Signals can be successfully detected. If the Flag Signal is successfully detected, then the testing operator may continue the testing; otherwise, the length of the signal may be increased until it is successfully detected. For an auto-adjustable process, the transmission and detection of Flag Signals may be determined automatically by software or hardware until a suitable signal length is selected.

In time sequence 400, the S-TTMF Flag Signal is followed by period of silence 406, which may be, for example, 0.20 second. The silence 406 is followed by the voice/video quality sample testing signal 408. As an example, test clips for audiovisual media may vary from 7.48 to 8.84 seconds. The voice/video quality sample testing signal 410 is followed by another period of silence 410. The time sequence for the first half of a single Test Circle ends with an E-TTMF Flag Signal 412, whose length is determined in the same manner as that of the S-TTMF Flag Signal 404. The two periods of silence are used to identify the end and start points of the S-TTMF Flag Signal and the S-TTMF Flag Signal, respectively, more reliably and accurately.

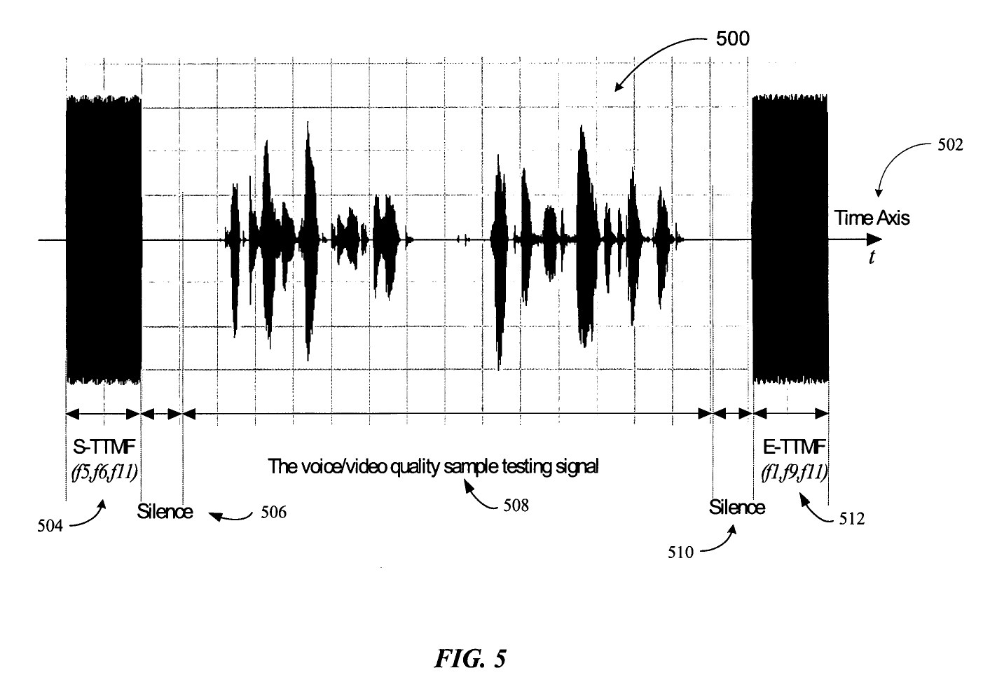

FIG. 5 is a graphic representation of the downlink 320 task of FIG. 3 and is similar to FIG. 4. Accordingly, the sequence and length of the Flag Signals 504, 512 and the voice/video quality sample testing signal 508 is the same as that of FIG. 4. However, because FIG. 5 is a graphic representation of the second half of a Test Circle, it also supports the function of exchanging quality measurement test results. Therefore, the S-TTMF Flag Signal 504 has encoded in it the integer portion of the voice/video quality testing result for the voice/video quality sample testing signal 408, FIG.4, according to Table 2, and the E-TTMF Flag Signal 512 has the two digit decimal portion according to Table 3. Again, the two periods of silence are used to identify the end and start points of the S-TTMF Flag Signal and the S-TTMF Flag Signal, respectively, more reliably and accurately.

In FIG. 6, a block diagram of an example of an implementation of a VVQT 600 used in a CFPR-VVQR system is shown in signal communication with a Network under Test 602. Three CPEs, CPE₁ 604, CPE₂ 606, and CPE₃ 606 are shown in signal communication with the Network under Test 602. The VVQT 600 may include four modules that are in signal communication with each other: the Decode/Record Module 620, the Testing Module 624, the Encode/Play Module 628, and the Storage Module 632. The Decode/Record Module 620 and the Encode/Play Module 628 may be in signal communication with the Network under Test 602 via signal path 612. A Test Circle may start with receipt of voice or video signal at Decode/Record Module 620 via signal path 612. Once the Decode/Record Module 620 is activated, it constantly monitors signals from the Network under Test 602 via signal path 612, looking for an S-TTMF Flag Signal. When an S-TTMF Flag Signal is detected by the Decode/Record Module 620, the testing process begins.

Having detected an S-TTMF Flag Signal, Decode/Record Module 620 starts to record the voice/video quality sample testing signal until an E-TTMF Flag Signal is detected. Upon receiving the voice/video quality sample testing signal, Decode/Record Module 620 sends the voice/video quality sample testing signal to Testing Module 624 via signal path 614. Decode/Record Module 620 also sends voice/video quality sample testing signal to Storage Module 626 via signal path 616.

Upon receipt of the voice/video quality sample testing signal, Testing Module 624 tests the voice/video quality sample testing signal using the appropriate measurement set and calculates a voice/video quality score, which may be a PESQ, PAMS, PSQM, or MOS score if the testing signal is a voice VoIP signal, or an objective parameter under ANSI T1.801.03-2003 in the case of video testing signal. At the same time, Storage Module 632 may save the recorded voice/video quality sample testing signal, with a time stamp, in cache memory 634, and may also save the test scores in another cache memory 636. After testing is completed, Storage Module 632 may save the voice/video quality sample testing signal and the test score on a hard drive or any other more permanent storage media that may be used to construct a database for analysis of the test results.

Testing Module 624 completes the testing function by sending the test score to Encode/Play Module 628 via signal path 626. Encode/Play Module 628 encodes the test score in a series of signals as shown in FIG. 5, that is, an S-TTMF Flag Signal and E-TTMF Flag Signal, together with another voice/video quality sample testing signal from a CPE (not shown) in signal communication with Encode/Play Module 628. The Test Circle ends with Encode/Play Module 628 sending the Flag Signals and a voice/video quality sample testing signal to the Network under Test 602 via signal path 612 for transmission to another VVQT connected to the Network under Test 602.

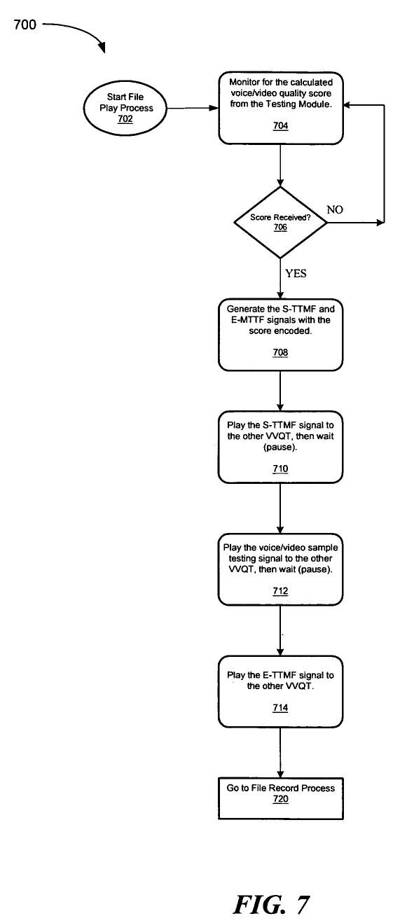

FIG. 7 is a flow chart 700 for a File Play Process within the Encode/Play Module 628, FIG. 6, of an example CFPR-VVQT system. The File Play Process starts in step 702. In step 704, the Encode/Play Module 628, FIG. 6, monitors for receipt of a voice/video quality testing result from Testing Module 624, FIG. 6, via signal path 626, FIG. 6. If it is determined in decision step 706 that a voice/video quality testing result has been received, the VVQT goes to step 708. Otherwise, the process returns to step 704 to continue monitoring for a test result.

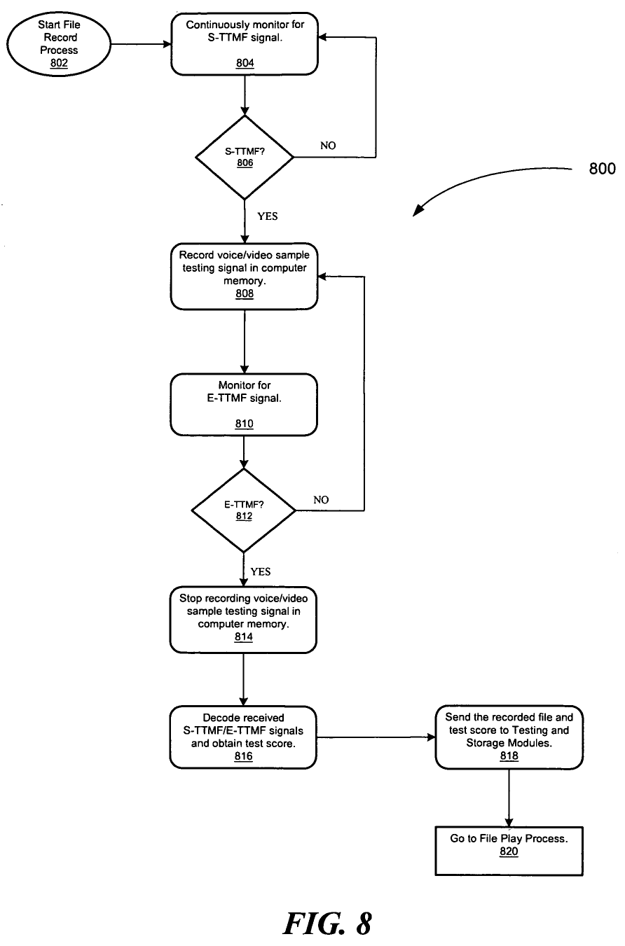

In step 708, the Encode/Play Module 628 generates an S-TTMF Flag Signal and an E-TTMF Flag Signal according to the test score received in accordance with Tables 2 and 3, respectively. In step 710, the Encode/Play Module 628 plays the S-TTMF Flag Signal to the other VVQT by transmitting the S-TTMF Flag Signal through the Network under Test. This is followed by a pause (the silence 506, FIG. 5). In step 712, the Encode/Play Module 628 plays a voice/video quality sample testing signal to the other VVQT by transmitting the sample testing signal through the Network under Test. Again, this followed by a pause (the silence 510, FIG. 5). In step 714, the Encode/Play Module 628 plays the E-TTMF Flag Signal to the other VVQT by transmitting the E-TTMF Flag Signal through the Network under Test. This completes the File play process, and in step 720, the CFPR-VVQT goes to the File Record process shown in FIG. 8.

FIG. 8 is a flow chart 800 for a File Record Process within the Decode/Record Module 620, FIG. 6, of an example CFPR-VVQT system. The File Play Process starts in step 802. In step 804, the Decode/Record Module 620, FIG. 6, continuously monitors incoming voice/video signals. In decision step 806, if the incoming voice/video signal is an S-TTMF Flag Signal, the process goes to step 808. Otherwise, the process returns to step 806 and continues to monitor the incoming voice/video signals. In step 808, the Decode/Record Module 620 begins recording a voice/video quality sample testing signal in computer memory.

While recording the voice/video quality sample testing signal, the process in step 810 monitors incoming voice/video signals for an E-TTMF Flag Signal. In decision step 812, if the incoming voice/video signal is not an E-TTMF Flag Signal, the process returns to step 808, continues recording the voice/video quality sample testing signal in computer memory, and then returns to step 810. If the incoming voice/video signal is an E-TTMF Flag Signal, the process goes to step 814, in which the recording of voice/video quality sample testing signals is ended. In step 816, the process decodes the recently-received S-TTMF and E-TTMF signals and obtains the test score. The process then goes to step 818 in which the recorded voice/video quality sample testing signals are sent to the Testing Module 624, FIG. 6, and the Storage Module 632, FIG. 6. This completes the File Record process, and in step 820, the CFPR-VVQT returns to the start of the File Play process shown in FIG. 7.

Persons skilled in the art will understand and appreciate, that one or more modules or submodules described in connection with FIG. 6 and the processes, sub-processes, or process steps described in connection with FIGS. 7 and 8 may be performed by hardware and/or software. Additionally, the CFPR-VVQT 300 may be implemented completely in software that would be executed within a microprocessor, general purpose processor, combination of processors, digital signal processor (“DSP”), and/or application specific integrated circuit (“ASIC”). If the process is performed by software, the software may reside in software memory (not shown) in the CFPR-VVQT 300. The software in software memory may include an ordered listing of executable instructions for implementing logical functions (i.e., “logic” that may be implemented either in digital form such as digital circuitry or source code or in analog form such as analog circuitry or an analog source such an analog electrical, sound or video signal), and may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

While the foregoing description refers to the use of a Continuous File Play Record Voice/Video Quality Test System, the subject matter is not limited to such a system. Any Voice/Video Quality Testing system that could benefit from the functionality provided by the components described above may be implemented in the Continuous File Play Record Voice/Video Quality Test System 300.

Moreover, it will be understood that the foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed:

1. A Continuous Bi-Directional File-Play-Record Voice and Video Quality Tester System (“CFPR-VVQT”) for measuring the signal transmission quality of a plurality of communication links from customer premises equipment (“CPE”) through a Network under Test to the CFPR-VVQT, the CFPR-VVQT comprising:
an Encode/Play Module in signal communication with at least one CPE through the Network Under Test;
a Decode/Record Module in signal communication with the Network Under Test and the Encode/Play Module;
a Testing Module in signal communication with the Encode/Play Module and the Decode/Record Module, wherein the Testing Module is configured to measure the signal transmission quality of the plurality of communication links and generate test results; and
a Storage Module in signal communication with the Decode/Record Module and the Testing Module.

2. The CFPR-VVQT of claim 1, wherein the Encode/Play Module is configured to:
receive quality testing sample signals related to a communication link from the at least one CPE;
generate start and end flag signals that indicate the start and end, respectively, of a transmission of a quality testing sample signal received from the at least one CPE;
receive the test results from the Testing Module, wherein the test results measure the signal quality of communication links from at least one other CPE in signal communication with the Network under Test;
embed the test results in the start and end flag signals; and
transmit the start flag signal, a quality testing sample signal from the at least one CPE, and the end flag signal through the Network under Test to the at least one other CPE.

3. The CFPR-VVQT of claim 2, wherein the Encode/Play Module is further capable of pausing the transmission through the Network under Test to the at least one other CPE between transmitting the start flag signal and the quality testing sample signal from the at least one CPE, and between transmitting the quality testing sample signal from the at least one CPE and the end flag signal.

4. The CFPR-VVQT of claim 2, wherein the Decode/Record Module is configured to:
receive the start and end flag signals and the quality testing sample signal from at least one other CPE;
identify the start and end flag signals;
record the quality testing sample signal from the at least one other CPE to memory in the CFPR-VVQT responsive to identifying the start flag signal;
terminate the recording of the quality testing sample signal from the at least one other CPE responsive to identifying the end flag signal;
decode the start and end flag signals to obtain the embedded test results; and
transmitting the recorded quality testing sample signal from the at least one other CPE and the embedded test results to the Storage Module.

5. The CFPR-VVQT of claim 4, wherein the Storage Module is configured to:
receive the quality testing sample signal from the Decode/Record Module;
receive embedded test results from the Decode/Record Module; and
store the quality testing sample signal and the embedded test results in a database.

6. The CFPR-VVQT of claim 5, wherein the start and end flag signals are Triple Tone Modulation Frequency (“TTMF”) tones.

7. The CFPR-VVQT of claim 6, wherein the test results from the Testing Module comprise a voice quality score that corresponds to the voice quality of the communication link, wherein the voice quality score is determined by utilizing a test measurement set chosen from the group consisting of:
a Perceptual Evaluation of Speech Quality (“PESQ”) test to determine the voice quality score;
a Perceptual Analysis/Measurement System (“PAMS”) test to determine the voice quality score;
a Perceptual Speech Quality Measurement (“PSQM”) test to determine the voice quality score; and
a Mean Opinion Score (MOS) test described by ITU-T Recommendation P.800.1 to determine the voice quality score.

8. The CFPR-VVQT of claim 6, wherein the test results from the Testing Module comprise a video quality score that corresponds to the video quality of the communication link, wherein the video quality score is determined by utilizing a test measurement set from American National Standards Institute (“ANSI”) T1.801.03-2003.

9. The CFPR-VVQT of claim 6, wherein the at least one CPE and the at least one other CPE are mobile communication devices configured to exchange test results from the Testing Module.

10. A method for measuring the signal quality of communication links from a plurality of customer premises equipment (“CPE”) through a Network under Test, the method comprising:
receiving first-CPE quality testing sample signals from a first CPE in signal communication with the Network under Test at a first Voice/Video Quality Tester (“VVQT”);
generating a first start flag signal and a first end flag signal at the first VVQT;
transmitting the first start flag signal from the first VVQT to a second VVQT in signal communication with the Network under Test;
transmitting a first-CPE quality testing sample signal from the first VVQT to the second VVQT through the Network under Test;
transmitting the first end flag signal from the first VVQT to the second VVQT through the Network under Test;
receiving the first start flag signal at the second VVQT;
decoding the first start flag signal at the second VVQT;
receiving the first-CPE quality testing sample signal at the second VVQT;
recording the first-CPE quality testing sample signal at the second VVQT;
receiving the first end flag signal at the second VVQT;
decoding the first start end signal at the second VVQT;
testing the first-CPE quality testing sample signal at the second VVQT and obtaining test results;
generating a second start flag signal and a second end flag signal at the second VVQT;
embedding the test results in the second start flag signal and the second end flag signal;
receiving second-CPE quality testing sample signals from a second CPE in signal communication with the Network under Test at the second VVQT;
transmitting the second start flag signal from the second VVQT to the first VVQT through the Network under Test;
transmitting a second-CPE quality testing sample signal from the second VVQT to the first VVQT through the Network under Test; and
transmitting the second end flag signal from the second VVQT to the first VVQT through the Network under Test.

11. The method of claim 10, further including:
(a) receiving the second start flag signal at the first VVQT;
(b) decoding the second start flag signal at the first VVQT;
(c) receiving the second-CPE quality testing sample signal from the second VVQT at the first VVQT;
(d) recording the second-CPE quality testing sample signal at the first VVQT;
(e) receiving the second end flag signal at the first VVQT;
(f) decoding the second start flag signal at the first VVQT;
(g) testing the second-CPE quality testing sample signal from the second VVQT at the first VVQT and obtaining test results;
(h) generating another first start flag signal and another first end flag signal at the first VVQT;
(i) embedding the test results in the another first start flag signal and the another first end flag signal; and
(j) transmitting the another first start flag signal, the another first-CPE quality testing sample signal, and the another first end flag signal from the first VVQT to the second VVQT through the Network under Test.

12. The method of claim 1, wherein the steps (a) through (j) of the method are repeated until terminated manually by operator intervention or automatically when the plurality of voice and video quality testing sample signals have all been measured.

13. The method of claim 12, wherein the first start flag signal, the second start flag signal, the first end flag signal, and the second end flag signal are TTMF tones.

14. The method of claim 13, further including:
maintaining the second-CPE quality testing sample signals recorded at the first VVQT and the test results obtained at the first VVQT in a database; and
maintaining the first-CPE quality testing sample signals recorded at the second VVQT and the test results obtained at the second VVQT in a database.

15. The method of claim 14, further including:
adjusting the length of the first start flag signal responsive to the decoding of the first start flag signal at the second VVQT;
adjusting the length of the first end flag signal responsive to the decoding of the first end flag signal at the second VVQT;
adjusting the length of the second start flag signal responsive to the decoding of the second start flag signal at the first VVQT; and
adjusting the length of the second end flag signal responsive to the decoding of the second end flag signal at the first VVQT.

16. A signal-bearing medium having software for continuously measuring the signal quality of a first communication link from a first customer premises equipment (“CPE”) through a Network under Test to a second CPE, and of a second communication link from the second CPE through the Network under Test to the first CPE, the signal-bearing medium comprising:
logic configured for receiving first-CPE quality testing sample signals from the first CPE at a first VVQT in signal communication with the Network under Test;
logic configured for receiving second-CPE quality testing sample signals from the second CPE at a second VVQT in signal communication with the Network under Test;
logic configured for generating first start and first end flag signals at the first VVQT;
logic configured for generating second start and second end flag signals at the second VVQT;
logic configured for transmitting a first start signal, a first-CPE quality testing sample signal, and a first end flag signal from the first VVQT to the second VVQT;
logic configured for transmitting a second start signal, a second-CPE quality testing sample signal, and a second end flag signal from the second VVQT to the first VVQT;
logic configured for receiving the second start signal, the second-CPE quality testing sample signal, and the second end flag signal from the second VVQT at the first VVQT;
logic configured for receiving the first start signal, the first-CPE quality testing sample signal, and the first end flag signals from the first VVQT at the second VVQT;
logic configured for testing the second-CPE quality testing sample signal received at the first VVQT;
logic configured for testing the first-CPE quality testing sample signals received at the second VVQT;
logic configured for transmitting test results obtained from testing the second-CPE quality testing sample signal received at the first VVQT to the second VVQT; and
logic configured for transmitting test results obtained from testing the first-CPE quality testing sample signal received at the second VVQT to the first VVQT.

17. The signal-bearing medium of claim 16, further including:
logic configured to repeat the transmission of the first start signal, a first-CPE quality testing sample signal, and the first end flag signal from the first VVQT to the second VVQT;
logic configured to repeat the transmission of the second start signal, another second-CPE quality testing sample signal, and the second end flag signal from the second VVQT to the first VVQT;
logic configured to repeat the testing of the another first-CPE quality testing sample signal transmitted from the first VVQT to the second VVQT; and
logic configured to repeat the testing of the another second-CPE quality testing sample signal transmitted from the second VVQT to the first VVQT.

18. The signal-bearing medium of claim 17, further including:
logic configured to delay the transmission of the first start flag signal, the first-CPE quality testing sample signal, and the first end flag signal from the first VVQT to the second VVQT responsive to the recording of first-CPE quality testing sample signals at the second VVQT; and
logic configured to delay the transmission of the second start signal, the second-CPE quality testing sample signal, and the second end flag signal from the second VVQT to the first VVQT responsive to the recording of second-CPE quality testing sample signals at the first VVQT.

19. The signal-bearing medium of claim 18, wherein the first start flag signal, the first end flag signal, the second start flag signal, and the second end flag signal are TTMF tones.

20. The signal-bearing medium of claim 19, further including:
logic configured for logging test results from the Testing Module of the first VVQT and from the Testing Module of the second VVQT; and
logic configured for maintaining the test results in a database.
